(19) United States
(12) Patent Application Publication
(10) Pub. No.: US 2026/0056070 A1
(43) Pub. Date: Feb. 26, 2026

(54) SYSTEMS AND METHODS FOR MEASURING WIRE ROPE TENSION

(71) Applicant: Amplified Industries, Inc., Boston, MA (US)

(72) Inventors: Sebastien K. Mannai, Boston, MA (US); Charles-Henri Clerget, Boston, MA (US); Eric Zhang, Dorchester, MA (US); Louis Creteur, Somerville, MA (US)

(73) Assignee: Amplified Industries, Inc., Boston, MA (US)

(21) Appl. No.: 19/105,485

(22) PCT Filed: Aug. 18, 2023
(86) PCT No.: PCT/US2023/030582

§ 371 Date: Feb. 21, 2025

Related U.S. Application Data
(60) Provisional application No. 63/400,737, filed on Aug. 24, 2022.

(51) Int. Cl. G01L 5/108

(52) U.S. Cl. CPC G01L 5/108

(57) ABSTRACT

Tension measuring devices for measuring tension in wire ropes, and associated systems and methods, are generally provided. Tension measuring devices described herein may use force signals related to forces applied to a tension measuring device by a laterally deflected wire rope extending therethrough to determine a tension of the wire rope. Such embodiments may allow for long term accurate measurement of tension in high load wire rope applications.

### RELATED APPLICATIONS

This application claims the benefit of priority under 35 U.S.C. § 119 (e) of U.S. Provisional Application Ser. No. 63/400,737, filed Aug. 24, 2022, the disclosure of which is incorporated herein by reference in its entirety.

### FIELD

Disclosed embodiments are related to systems and methods for measuring wire rope tension.

### BACKGROUND

Tension measurement in wire ropes under relatively high tension is important in systems for drilling, pumping, or lifting oil; elevators; cranes; and a variety of other technologies. In-line tension gauges where the entire force is applied to the tension gauge have been used for measuring the forces present in these applications.

### SUMMARY

Tension measuring devices for measuring tension in wire ropes, and associated systems and methods, are generally provided. Tension measuring devices described herein may use force signals related to forces applied to a tension measuring device by a laterally deflected wire rope extending therethrough to determine a tension of the wire rope. Such embodiments may allow for long term accurate measurement of tension in high load wire rope applications.

According to one aspect, a tension measuring device configured to measure tension in a wire rope is provided. In some embodiments, the tension measuring device comprises: a first support configured to support a first portion of the wire rope when the wire rope is disposed in the tension measuring device; a second support configured to support a second portion of the wire rope when the wire rope is disposed in the tension measuring device, wherein the first and second supports are rigidly coupled together; a clamp configured to be disposed against an intermediate portion of the wire rope between the first portion and the second portion of the wire rope when the wire rope is disposed in the tension measuring device; at least one fastener configured to displace at least a portion of the clamp to laterally deflect the intermediate portion of the wire rope; a spacer configured to limit displacement of the clamp and the associated lateral deflection of the intermediate portion of the wire rope; and a sensor configured to output a signal related to one or more forces applied to the tensioning measuring device by the wire rope.

In another aspect, a tension measuring device configured to measure tension in a wire rope is provided. According to some embodiments, the tension measuring device comprises: a first support configured to support a first segment of the wire rope when the wire rope is disposed in the tension measuring device, a second support configured to support a second segment of the wire rope when the wire rope is disposed in the tension measuring device, wherein the first and second supports are rigidly coupled together, a clamp configured to be disposed against an intermediate portion of the wire rope between the first portion and the second portion of the wire rope when the wire rope is disposed in the tension measuring device, and at least one fastener configured to displace the clamp to laterally deflect the intermediate portion of the wire rope; a sensor configured to output a signal related to one or more forces applied to the tension measuring device by the wire rope; and a processor, configured to determine a tension in the wire rope based on a signal from the sensor and a diameter of the wire rope when the wire rope is disposed in the tension measuring device.

In yet another aspect, a method of determining a tension in a wire rope is provided. In some embodiments, the method comprises: obtaining information related to a lateral deflection of the wire rope within a tension measuring device; receiving a signal from a sensor, wherein the signal is related to one or more forces applied to the tension measuring device by the wire rope; and determining the tension in the wire rope based at least in part on the information, the signal, and a diameter of the wire rope.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1A presents a non-limiting cross-sectional schematic illustration of a tension measuring device, according to some embodiments;

FIG. 1B presents a non-limiting cross-sectional schematic illustration of a tension measuring device, according to some embodiments;

FIG. 1C presents a non-limiting cross-sectional schematic illustration of a tension measuring device and a wire rope disposed therein, according to some embodiments;

FIG. 2 presents a non-limiting sectional perspective illustration of a tension measuring device incorporated into a system for pumping oil, according to some embodiments

FIG. 3 presents a non-limiting, schematic representation of a method of tension measurement, according to some embodiments; and

FIG. 4 presents a non-limiting, schematic representation of a method of tension measurement, according to some embodiments.

### DETAILED DESCRIPTION

Systems and methods for tension measurement with improved accuracy are provided herein. Often, wire rope tension is measured using an in-line tension measuring device, which may be difficult to add or remove. As an alternative, a tension measuring device may be affixed to a wire rope—but such tension measuring devices can be difficult to calibrate, and may experience calibration drift over time. The present disclosure is directed towards tension measuring devices and methods of measuring tension that, according to some embodiments, may be used to accurately measure tension over long time periods. The devices and methods described herein may produce accurate tension measurements for wire ropes under tension. Other advantages, such as ease of installation, accuracy over broad temperature ranges, and other potential benefits may be provided by the systems and methods described herein.

In one aspect, a tension measuring device is provided. According to some embodiments, the tension measuring device is capable of measuring tension in a wire rope. A wire rope may be disposed in the tension measuring device such that the wire rope extends through at least a portion of the tension measuring device. For example, the wire rope may be disposed in the tension measuring device such that the wire rope extends between two or more portions of the tension measuring device. A tension measuring device described herein may comprise one or more components configured to interact with a wire rope, when the wire rope is disposed in the tension measuring device. For example, a tension measuring device may comprise a support and/or a clamp, as described in greater detail below, that are configured to deflect a portion of the wire rope in a lateral direction perpendicular to a longitudinal axis of the wire rope. The resulting deflection, dimensions of the wire rope, and/or other appropriate parameters as elaborated on further below may be used to determine the tension present in the wire rope.

In some embodiments, a tension measuring device comprises two or more supports. The supports may be configured to support two or more corresponding portions of the wire rope extending there between when the wire rope is disposed in the tension measuring device. Depending on the embodiment, the tension measuring device may comprise exactly 2 supports, though embodiments in which 3, 4, 5, 6, 7, 8, 9, 10, or more supports configured to support portions of the wire rope when the wire rope is disposed in the tension measuring device are used are also contemplated, as the disclosure is not so limited. In some embodiments, the tension measuring device comprises a first support configured to support a first portion of the wire rope when the wire rope is disposed in tension measuring device and a second support configured to support a second portion of the wire rope when the wire rope is disposed in the tension measuring device with the wire rope extending between the first and second supports.

As elaborated on further below, the two or more supports of the tension measuring device (e.g., a first support and a second support) may be rigidly coupled together. For example, the supports may be separately connected to different spaced apart portions of a rigid body. This may include direct connection to the rigid body, indirect connections to the rigid body, integral formation with the rigid body, and/or any other appropriate type of arrangement. Any appropriate structure capable of functioning as a rigid body that does not undergo permanent plastic or creep deformation during operation under a rated load may be used as the disclosure is not limited to any particular construction of a rigid body capable of supporting the two or more supports of a tension measuring device.

As noted above, in some embodiments, the tension measuring devices disclosed herein may comprise a clamp. A clamp may be situated between a first support and a second support of the tension measuring device. In some embodiments, at least a portion of a clamp is configured to be disposed against an intermediate portion of the wire rope between a first portion of the wire rope supported by a first support and a second portion of the wire rope supported by a second support. Such a configuration is described in greater detail with reference to the figures below. In some embodiments, a clamp is capable of deflecting an intermediate portion of a wire rope relative to a first portion of a wire rope contacting a first support and a second portion of a wire rope contacting a second support. A clamp may be configured to deflect the intermediate portion of the wire rope laterally, relative to a longitudinal axis of the first portion of the wire rope and the second portion of the wire rope, when the wire rope is disposed within the tension measuring device. Deflection of a portion of the wire rope by the clamp may be used to help determine a tension of the wire rope, as described below with reference to the figures.

The tension measuring device may comprise at least one fastener configured to displace at least a portion of a clamp of a tension measuring device against the wire rope to provide the desired lateral displacement of the wire rope. In some embodiments, when a wire rope is disposed within the tension measuring device, displacement of a clamp by a fastener may compress the clamp against the intermediate portion of the wire rope between the two wire rope portions contacting the first and second supports of the tension measuring device. This may again result in the above noted lateral deflection of the intermediate portion of the wire rope. Any of a variety of appropriate fasteners may be used, and many of these are discussed in greater detail with reference to the figures below.

In some embodiments, it may be advantageous to control a magnitude of the lateral deflection of a clamp and/or a segment of wire rope contacting the clamp. Commonly, tension measuring devices rely on large lateral deflection of wire rope segments. However, large lateral deflections of a wire rope may introduce nonlinearities into tension measurements, and can be associated with undesirable wear or creep of the tension measuring device, resulting in a calibration drift over time. Without wishing to be bound by any particular theory, nonlinearity in wire rope tension and/or calibration drift of the tension measuring device may result from slippage of wire strands of the wire rope relative to one another and/or permanent deformation of the tension measuring device over time. Strand slippage may be particularly problematic during tension measurement of wire ropes. The likelihood of strand slippage may depend on the condition of the wire rope, and the size of the strands, and can complicate accurate measurement of tension within the wire rope, particularly over long periods. In the context of the present disclosure, it has been inventively recognized that limiting lateral deflection of the wire rope may simplify modeling of wire rope tension, and thereby provide an advantage over traditional tension measurement devices. However, a significant challenge associated with using a small lateral deflection to measure tension is that uncertainty in the extent of lateral deflection can have a larger impact on the tension measured within a wire rope. While lateral deflection of a tension measuring device can be precisely controlled using a measurement tool, such measurement tools can be costly and difficult to use, and may be prone to user error.

In view of the above, the Inventors have recognized that it may be desirable to limit the movement of an associated clamp to avoid compressing (i.e., bottoming out) a wire rope directly between a clamp and one or more other portions of an associated portion of the tension measuring device such as a frame or other rigid body of the device. This may be done by limiting the travel of an associated fastener and clamp to one or more predefined distances. For example, a tension measuring device described herein may comprise a spacer capable of limiting a lateral deflection of a clamp. In some embodiments, a spacer is configured to limit a lateral deflection of a clamp of a tension measuring device. According to some embodiments, a spacer acts as a hard stop for the fastener or clamp, thus limiting lateral deflection of a clamp to a precise, known value. When a wire rope is disposed in the tension measuring device, the spacer may be configured such that a portion of wire rope deflected by the clamp is deflected to a fixed position determined by the spacer. As a result, the spacer can limit lateral deflection of the wire rope portion to a pre-set value.

Any appropriate type of spacer may be associated with a fastener of a tension measuring device may be used to control movement of a clamp of the device. For example, the spacer may be a part of the fastener, or may be a separate component that interacts with a fastener, as described in greater detail with reference to the figures below. In some embodiments, the spacer is separate from the fastener and is disposed between the clamp and a rigid body extending between the first support and the second support, e.g., a structure with a through hole that the fastener extends through. In other embodiments, the spacer is a protrusion of the clamp with a known length that engages with a rigid body of the device to prevent additional displacement of the clamp. Other embodiments, without a spacer, are also possible. For example, a tension measuring device that comprises a threaded bore with a precise depth, a threaded fastener with a precise length of threaded shaft, a clamp configured to contact the wire rope with the load-cell, or other appropriate structure may be used such that a fastener of a known length bottoms out at a precise, known depth to provide a known amount of displacement of the clamp as elaborated on below. As another alternative to a spacer, an electronic position sensor or switch could be used to alert the user that a precise displacement has been achieved. Of course while specific constructions for limiting displacement of the clamp are provided, the disclosure is not limited to only these specific constructions.

In some aspects, the disclosure is directed towards a method of determining tension in a wire rope. In some embodiments, a method comprises obtaining information related to a lateral deflection of a wire rope within a tension measuring device. The information may be obtained by measuring the deflection of the wire rope or the lateral displacement of the clamp. According to some embodiments, the method comprises deflecting the wire rope to a pre-set value using a clamp, a fastener, and/or a spacer of a tension measuring device. In some embodiments, information related to a lateral deflection of the wire rope is obtained by choosing a spacer of known geometry and obtaining information related to a fastener or clamp of the tension measuring device (e.g., whether the fastener or clamp has reached a limit determined by the spacer). However, other appropriate methods for obtaining the lateral deflection may be used including, recorded measurements, sensors, manual inputs, predetermined values for a given tension measurement device, and/or any other appropriate method for obtaining the lateral deflection associated with measurements of a wire rope.

The tension measuring devices disclosed herein may comprise a sensor configured to sense one or more parameters related to forces applied to tension measuring device by a wire rope positioned therein. For example, a load cell, force sensor, extensometer, strain gauges, and/or any other sensor or set of sensors capable of directly or indirectly measuring the forces applied to the tension measuring device may be used.

According to some embodiments, a method comprises determining the tension of a wire rope based at least in part on a signal from a sensor of a tension measuring device. For example, a method may comprise determining tension in a wire rope based at least in part on a signal from a sensor related to one or more forces applied to tension measuring device by the wire rope, information about lateral displacement of a wire rope, and one or more properties of the wire rope (e.g., wire rope composition, wire rope braid, wire rope diameter, wire rope age and/or condition). Implementation of such a method is described further below in regards to the figures.

In the context of the present disclosure, the Inventors have recognized that a temperature of the tension measuring device may impact measurement of a tension due to effects such as thermal expansion, calibration, electronic properties, wear, and/or creep of one or more components of the tension measuring device. For example, a force sensor may produce a signal with a temperature dependence. Therefore, ambient temperature measurements by a temperature sensor may be used to improve the accuracy of measured tension values of a wire rope by accounting for one or more temperature dependent effects such as thermal expansion, calibration, electronic properties, wear, and or creep. Accounting for temperature effects may be particularly important in the context of wire ropes used for oil drilling, pumping, or lifting, where it may be desirable for a tension sensor to be able to remain calibrated over a relatively broad range of ambient temperatures and/or for long durations. Any of a variety of appropriate temperature sensors may be used. For example, the temperature sensor may be a thermocouple, a resistance temperature detector, a thermistor, or a semiconductor-based integrated circuit temperature sensor.

Typically, ambient temperature of the device can be assumed to be comparable to the temperature internal to the device, since the tension measuring device does not experience much heating or cooling during operation. Of course, in some embodiments, a temperature internal to the device may be measured for improved accuracy.

A sensor (e.g., a force sensor) of a tension measuring device may be calibrated to measure any of a variety of tensions. In some embodiments, a sensor is calibrated to measure tensions greater than or equal to 500 N, greater than or equal to 1,000 N, greater than or equal to 2,000 N, greater than or equal to 5,000 N, greater than or equal to 10,000 N, greater than or equal to 20,000 N, greater than or equal to 30,000 N, greater than or equal to 40,000 N, greater than or equal to 50,000 N, greater than or equal to 60,000 N, greater than or equal to 70,000 N, greater than or equal to 80,000 N, greater than or equal to 90,000 N, or greater. In some embodiments, a sensor is calibrated to measure tensions less than or equal to 250,000 N, less than or equal to 225,000 N, less than or equal to 200,000 N, less than or equal to 175,000 N, less than or equal to 150,000 N, less than or equal to 125,000 N, less than or equal to 100,000 N, less than or equal to 50,000 N, less than or equal to 40,000 N, less than or equal to 30,000 N, less than or equal to 20,000 N, or less. Combinations of these ranges are also possible. For example, in some embodiments, a sensor is calibrated to measure a tension of greater than or equal to 500 N and less than or equal to 50,000 N. As another example, in some embodiments, a sensor is calibrated to measure a tension of greater than or equal to 500 N and less than or equal to 250,000 N. However, measured tensions both greater than and less than those noted above are also contemplated as the disclosure is not so limited.

A sensor (e.g., a force sensor) of a tension measuring device may be calibrated to measure the measure any of a variety of forces in order to determine rope tension. In some embodiments, a sensor is calibrated to measure forces greater than or equal to 500 N, greater than or equal to 1,000 N, greater than or equal to 2,000 N, greater than or equal to 5,000 N, greater than or equal to 10,000 N, greater than or equal to 20,000 N, greater than or equal to 30,000 N, greater than or equal to 40,000 N, greater than or equal to 50,000 N, greater than or equal to 60,000 N, greater than or equal to 70,000 N, greater than or equal to 80,000 N, greater than or equal to 90,000 N, or greater. In some embodiments, a sensor is calibrated to measure forces less than or equal to 100,000 N, less than or equal to 50,000 N, less than or equal to 40,000 N, less than or equal to 30,000 N, less than or equal to 20,000 N, or less. Combinations of these ranges are also possible. For example, in some embodiments, a sensor is calibrated to measure a force of greater than or equal to 500 N and less than or equal to 100,000 N. However, measured tensions both greater than and less than those noted above are also contemplated as the disclosure is not so limited.

A tension measuring device may remain calibrated at any of a variety of operating temperature ranges. In some embodiments, a sensor remains calibrated at operating temperatures of greater than or equal to −20° C., greater than or equal to −10° C., greater than or equal to 0° C., greater than or equal to 10° C., greater than or equal to 20° C., greater than or equal to 30° C., or greater. In some embodiments, a tension measuring device remains calibrated at a temperature of less than or equal to 50° C., less than or equal to 40° C., less than or equal to 30° C., less than or equal to 20° C., less than or equal to 10° C., less than or equal to 0° C., less than or equal to −10° C., or less. Combinations of these ranges are possible. For example, in some embodiments, a sensor remains calibrated at temperatures of greater than or equal to −20° C. and less than or equal to 50° C. However, calibration at temperatures both greater than and less than those noted above are also contemplated as the disclosure is not so limited.

In some contexts, a tension measuring device may remain calibrated for a substantial period of time without recalibration or other intervention. In some embodiments, a tension measuring device may remain calibrated for a period of greater than or equal to 6 months, greater than or equal to 8 months, greater than or equal to 10 months, greater than or equal to 12 months, greater than or equal to 14 months, greater than or equal to 16 months, or greater. In some embodiments, a tension measuring device remains calibrated for a period of less than or equal to 24 months, less than or equal to 22 months, less than or equal to 20 months, less than or equal to 18 months, less than or equal to 16 months, less than or equal to 14 months, or less. Combinations of these ranges are possible. For example, in some embodiments, a tension measuring device remains calibrated for a period of greater than or equal to 6 months and less than or equal to 24 months. However, calibration for time periods both greater than and less than those noted above are also contemplated as the disclosure is not so limited.

Combinations of the ranges described in the preceding paragraphs are also possible. For example, in some embodiments, a sensor is calibrated at temperatures greater than or equal to −20° C. and less than or equal to 50° C. for a time period of greater than or equal to 6 months. Of course, it should be understood that a tension measuring device may have more than one sensor, and each sensor may independently be calibrated as described above.

In some embodiments, a wire rope is disposed in a tension measuring device. A wire rope may have any of a variety of conditions, some of which may affect tension measurement. For example, a wire rope may be new or rusty, where a lubricated new rope may undergo increased amounts of wire slippage within the wire rope as compared to older wire ropes where the wires are rusted and/or lubricant may no longer be present. A wire rope may also be braided or twisted, both of which may be associated with different twist patterns and/or any of a variety of appropriate braids (e.g., the wire rope may be hollow braided, solid braided, or double-braided). A wire rope may be plaited with any of a variety of appropriate plaits. For example a braided wire rope may comprise an 8 plait construction, a 16 plait construction, a 24 plait construction, a 32 plait construction, or a 48 plait construction. Thus, as elaborated on below, these properties related to a wire rope construction may be used when determining a tension present in a wire rope.

Depending on the embodiment, the disclosed tension measuring devices and/or methods may be used for any desired application. For example, in some embodiments, the wire rope is a wire rope of a system for drilling, pumping, or lifting oil. For example, the wire rope may be a wire rope of a pumpjack or an oil rig. A specific example is described below, with reference to the figures. However, the disclosure is not limited to tension measuring devices for use in systems for drilling, pumping, or lifting oil, and a tension measuring device as described herein may be used in any of a variety of appropriate systems, including, but not limited to elevators, cranes, and towing systems.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

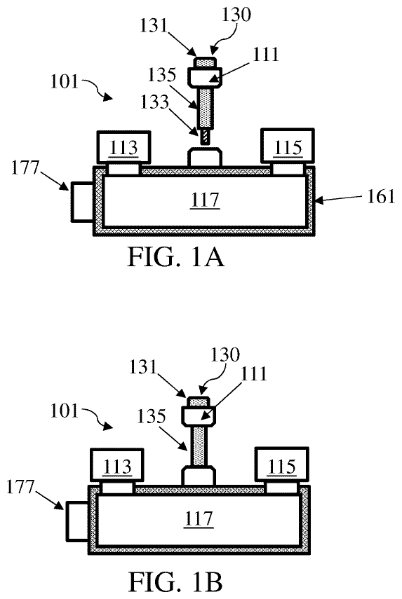

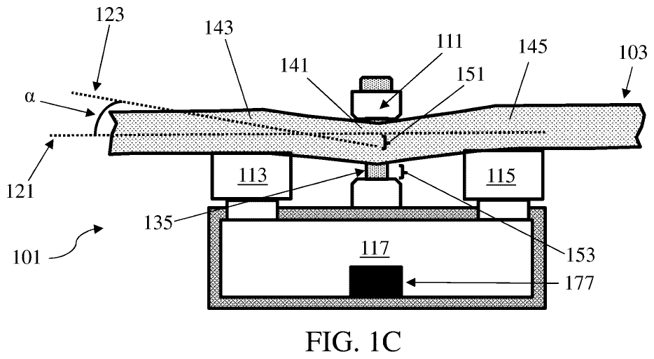

FIG. 1A presents a side-view schematic illustration of nonlimiting tension measuring device 101 comprising spaced apart first support 113 and second support 115, which are rigidly coupled to one another via a rigid body, such as depicted housing 161. A sensor 117 for measuring one or more signals related to forces applied to the housing by an associated wire rope may be disposed in or on the housing. First support 113 and second support 115 are configured such that a wire rope disposed in tension measuring device 101 would be capable of applying a force to the housing, which may be measured by sensor 117.

Supports 113 and 115 may be configured to support a wire rope. For example, one or both of supports 113 and 115 may comprise a groove or a cradle sized and shaped to match at least a portion of a profile of the wire rope (e.g., this may reduce the maximum pressure applied to an exterior profile of the wire rope while reducing or preventing lateral slippage of the wire rope relative to the supports). Additionally, or alternatively, a support may comprise one or more raised portions configured to create a channel for the wire rope. Other support designs may also be used as the disclosure is not so limited.

In some embodiments, a distance between a first support and a second support of a tension measuring device is greater than or equal to 5 cm, greater than or equal to 8 cm, greater than or equal to 10 cm, greater than or equal to 12 cm, greater than or equal to 15 cm, greater than or equal to 18 cm, greater than or equal to 20 cm, greater than or equal to 22 cm, greater than or equal to 25 cm, greater than or equal to 28 cm, or greater. In some embodiments, a distance between a first support and a second support of a tension measuring device is less than or equal to 40 cm, less than or equal to 38 cm, less than or equal to 35 cm, less than or equal to 32 cm, less than or equal to 30 cm, less than or equal to 28 cm, less than or equal to 25 cm, less than or equal to 22 cm, less than or equal to 20 cm, less than or equal to 18 cm, less than or equal to 15 cm, less than or equal to 12 cm, less than or equal to 10 cm, less than or equal to 8 cm, or less. Combinations of these ranges are also possible. For example, in some embodiments, a distance between a first support and a second support of a tension measuring device is greater than or equal to 5 cm and less than or equal to 40 cm. However, distance between supports that are both greater than and less than those noted above are also contemplated as the disclosure is not so limited. A length of a wire rope extending between the supports of a tension measuring device may exhibit similar lengths as those noted above.

In some embodiments, sensor 117 is a force sensor as described above that is configured to sense one or more forces applied to a rigid body, such as the housing 161, of the tension measuring device 101. Specifically, sensor 117 may be configured to measure one or more forces transmitted from first support 113 and second support 115 to the rigid body due to the lateral deflection and support of a wire rope disposed in the tension measuring device. Sensor 117 may be configured to transmit a signal related to the one or more sensed forces. The signal may be transmitted in any of a variety of suitable ways including wirelessly, or via a hardwired connection. In some embodiments, sensor 117 is configured to transmit signal to an external processor that is separate from tension measuring device 101. However, in some embodiments, tension measuring device 101 comprises a processor and/or any of a variety of other suitable computer components, and the signal is transmitted from sensor 117 to the processor. Regardless of location, the one or more processors associated with the tension measuring device may be associated with non-transitory computer readable memory that includes instructions that when executed by the one or more processors implement any of the methods disclosed herein.

As shown in FIG. 1A, tension measuring device 101 may further comprise a temperature sensor 177. It should, of course, be understood that although the embodiment of FIG. 1A shows temperature sensor 177, the temperature sensor is not required. However, as discussed above, the temperature sensor 177 may be useful for calibrating, maintaining calibration of, and/or interpreting a signal from sensor 117. Temperature sensor 177 may be configured to transmit a signal related to an ambient temperature. The signal may be transmitted in any of a variety of suitable methods including wirelessly, or via a hardwired connection. In some embodiments, temperature sensor 177 is configured to transmit signal to an external processor that is separate from tension measuring device 101. However, in some embodiments, tension measuring device 101 comprises a processor and/or any of a variety of other suitable computer components, and the signal is transmitted from sensor 177 to one or more computer components of tension measuring device.

In some embodiments, a tension measuring device such as tension measuring device 101 of FIG. 1A comprises a housing, such as housing 161. In some embodiments, the housing at least partially encloses one or more sensors of a tension measuring device. For example, the housing may at least partially enclose a force sensor. Referring to FIG. 1A, housing 161 at least partially encloses force sensor 117. The housing may serve any of a variety of purposes, including but not limited to shielding a sensor from external conditions (e.g., rainfall) that could negatively affect the performance of a tension measuring device. In some embodiments, the housing at least partially encloses one or more computer components as described herein. In some embodiments, the housing is a mono-component housing. However, the housing may comprise a plurality of housing components, which may be rigidly coupled to one another. Additionally, embodiments in which a monolithic rigid body with externally mounted components are used are also contemplated.

As shown in FIG. 1A, in some embodiments, housing 161 of tension measuring device 101 rigidly couples a plurality of supports (e.g., support 113 and support 115 of FIG. 1A) of tension measuring device 101. A support may be mounted to the housing in any appropriate fashion such that the supports extend out from the housing in a common direction. This may include a support may be integrally formed with a housing component, threaded fasteners, welding, mechanical connections, and/or any other appropriate connection method. For example, in some embodiments, the housing comprises two supports that are spaced apart along a length of the housing and extend outwards from the housing in a radial direction relative to a longitudinal axis of the device. The supports may be connected to the housing in any appropriate fashion. Thus, supports 113 and 115 of tension measuring device 101 may be configured to support separate portions of a wire rope above housing 161 extending therebetween to limit or prevent contact between the wire rope and an underlying portion of the housing when the wire rope is disposed within the tension measuring device.

As noted above, although tension measuring device 101 comprises housing 161, a housing is not necessary. In some embodiments, a tension measuring device does not comprise a housing. Instead, the first support and the second support may be rigidly coupled to one another via any appropriate rigid body, including for example a solid component. Thus, the current disclosure is not limited to only the constructions shown in the figures.

In FIG. 1A, tension measuring device 101 may further comprise a clamp 111, which is mechanically coupled to fastener 130. As shown in FIG. 1A, clamp 111 may be mechanically coupled to housing 161, or other rigid body, by the fastener such that the clamp may be displaced towards and away from the rigid body at a location between the first and second supports 113 and 115. The clamp of a tension measuring device may be situated at any of a variety of appropriate positions of the tension measuring device. For example, as shown in FIG. 1A, clamp 111 is about equidistant from first support 113 and second support 115. Placement of clamp 111 about equidistant from first support 113 and second support 115 may have any of a variety of advantages. For example, in some embodiments, placement of clamps 111 about equidistant from first support 113 and second support 115 permits a wire rope disposed in tension measuring device 101 to apply force symmetrically to first support 113 and second support 115. Symmetric application of force to the supports may, in some embodiments, simplify calculation of tension in the wire rope, reduce wear on one or both supports, improve measurement accuracy, and/or provide any of a number of other advantages.

As shown in FIG. 1A, clamp 111 may comprise a component that extends across at least a portion of the housing 161, or other rigid body. For example, a clamp may extend between and be coupled with two fasteners 130 disposed on opposing sides of a longitudinal axis of the housing and that are coupled with the housing. Thus, the fasteners may be used to move the clamp towards or away from the housing. However, clamp 111 is not limited to this specific construction, and may have any of a variety of different forms. For example, a clamp may be provided in the form of a hinged structure, a one-bolt clamp, a magnetic clamp, a hand-latched clamp, and/or any other appropriate type of clamp.

FIG. 1A shows fastener 130 as a single component comprising a head 131 and threaded shaft 133. The fastener may be configured to mechanically couple a clamp to the housing 161 in a variety of suitable ways. For example, fastener 130 shown in FIG. 1A is configured to mechanically engage with a top portion of clamp 111 by passing through a hole in the top portion of clamp 111, such that head 131 applies a force to the top portion of clamp 111. In some embodiments, the fastener comprises a threaded shaft 133 that can be threaded into a corresponding portion of the housing to attach the clamp to the housing. In some embodiments, the fastener is a screw, bolt, pin, rivet, or any other appropriate fastener.

As noted above, in some embodiments a fastener may be associated with a spacer to limit a distance the fastener, and associated clamp, may be displaced. For example, referring again to FIG. 1A, fastener 130 may include spacer 135 which may correspond to an unthreaded portion of the fastener shaft. Alternatively, the spacer may correspond to a solid body with a through hole formed there through extending from an upper surface to a lower opposing surface of the support such that the fastener extends through the through hole. Thus, a length of the spacer may again limit a length of the fastener when fully engaged with the housing to a predetermined length. By doing this, the spacer may be configured to provide a known amount of lateral deflection of a wire rope and to prevent excessive deflection of a wire rope by a clamp. For example, in FIG. 1A, spacer 135 is configured such that clamp 111 cannot be closed by an amount exceeding a length of spacer 135. A spacer may have any of a variety of suitable cross-sections. For example, spacer 135 of FIG. 1A is a cylinder having a circular cross-section. However, spacers may have any of a variety of suitable cross-sections, including a triangular cross-section, a square cross-section, a hexagonal cross-section, or an elliptical cross-section, and the disclosure is not so limited.

A spacer (e.g., spacer 135 as shown in FIGS. 1A-1C) may have any of a variety of appropriate lengths. In some embodiments, a spacer has a length of greater than or equal to 5 mm, greater than or equal to 8 mm, greater than or equal to 10 mm, greater than or equal to 12 mm, greater than or equal to 15 mm, greater than or equal to 18 mm, greater than or equal to 20 mm, greater than or equal to 22 mm, greater than or equal to 25 mm, greater than or equal to 28 mm, greater than or equal to 30 mm, greater than or equal to 32 mm, greater than or equal to 35 mm, greater than or equal to 38 mm, greater than or equal to 40 mm, greater than or equal to 42 mm, greater than or equal to 45 mm, greater than or equal to 48 mm, greater than or equal to 50 mm, greater than or equal to 52 mm, greater than or equal to 55 mm, or greater. In some embodiments, a spacer has a length of less than or equal to 75 mm, less than or equal to 72 mm, less than or equal to 70 mm, less than or equal to 68 mm, less than or equal to 65 mm, less than or equal to 62 mm, less than or equal to 60 mm, less than or equal to 58 mm, less than or equal to 55 mm, less than or equal to 52 mm, less than or equal to 50 mm, less than or equal to 48 mm, less than or equal to 45 mm, less than or equal to 42 mm, less than or equal to 40 mm, less than or equal to 38 mm, less than or equal to 35 mm, less than or equal to 32 mm, less than or equal to 30 mm, less than or equal to 28 mm, less than or equal to 25 mm, less than or equal to 22 mm, less than or equal to 20 mm, less than or equal to 18 mm, less than or equal to 15 mm, less than or equal to 12 mm, less than or equal to 10 mm, or less. Combinations of these ranges are possible. For example, in some embodiments, a spacer has a length of greater than or equal to 5 mm and less than or equal to 75 mm. However, lengths both greater than and less than those noted above are also contemplated as the disclosure is not so limited.

In some embodiments, a spacer length exceeds a diameter of a wire rope disposed in a tension measuring device. Use of a spacer with a length exceeding a diameter of the wire rope may, advantageously, create a gap between a displaced, intermediate wire rope portion and a housing, or other underlying portion, of the tension measuring device. For example, as shown in FIG. 1C, spacer 135 is longer than the diameter of wire rope 103 disposed in tension measuring device 101, creating gap 153 between wire rope 103 and tension measuring device 101. The existence of a gap between a wire rope and a tension measuring device may be desirable for reducing friction on the clamp, and for improving accuracy of a tension measurement. For example, if spacer 135 were removed from fastener 130, clamp 111 could be tightened to eliminate gap 153. However, the elimination of gap 153 would result in a higher deformation of the wire rope 130, which may reduce the accuracy of tension measurement for reasons discussed elsewhere herein.

Clamp 111 of FIG. 1A is shown in an open configuration, where a wire rope may be disposed within tension measuring device 101 without experiencing any deflection caused by the tension measuring device. In contrast, FIG. 1B presents a side-view schematic illustration of the tension measuring device of FIG. 1A in a closed configuration. As shown, fastener 130 has displaced a top portion of clamp 111 laterally, such that clamp 111 is closed to the length of spacer 135.

FIG. 1C illustrates tension measuring device 101 of FIGS. 1A-1B, in which wire rope 103 is disposed in the device. Specifically, wire rope 103 comprises first portion 143 supported by first support 113, second portion 145 supported by second support 115, and intermediate portion 141 that extends between first portion 143 and second portion 145. Intermediate portion 141 is disposed against and deflected by clamp 111 radially inwards towards the body 161. Clamp 111 is shown in a closed configuration (as in FIG. 1B), resulting in lateral deflection of intermediate portion wire rope 103.

Wire rope 103 disposed in tension measuring device 101 of FIG. 1C may have any of a variety of suitable diameters depending on the desired application. In some embodiments, a wire rope has a diameter of greater than or equal to 5 mm, greater than or equal to 8 mm, greater than or equal to 10 mm, greater than or equal to 12 mm, greater than or equal to 15 mm, greater than or equal to 18 mm, greater than or equal to 20 mm, greater than or equal to 22 mm, greater than or equal to 25 mm, greater than or equal to 28 mm, greater than or equal to 30 mm, greater than or equal to 32 mm, greater than or equal to 35 mm, greater than or equal to 38 mm, greater than or equal to 40 mm, greater than or equal to 42 mm, greater than or equal to 45 mm, greater than or equal to 48 mm, or greater. In some embodiments, a wire rope has a diameter of less than or equal to 52 mm, less than or equal to 50 mm, less than or equal to 48 mm, less than or equal to 45 mm, less than or equal to 42 mm, less than or equal to 40 mm, less than or equal to 38 mm, less than or equal to 35 mm, less than or equal to 32 mm, less than or equal to 30 mm, less than or equal to 28 mm, less than or equal to 25 mm, less than or equal to 22 mm, less than or equal to 20 mm, less than or equal to 18 mm, less than or equal to 15 mm, less than or equal to 12 mm, less than or equal to 10 mm, or less. Combinations of these ranges are possible. For example, in some embodiments, a wire rope has a diameter of greater than or equal to 5 mm and less than or equal to 52 mm. However, wire rope diameters both greater than and less than those noted above are also contemplated as the disclosure is not so limited.

In some embodiments, wire rope 103 is under tension when disposed in tension measuring device 101. In some embodiments, a tension measuring device is configured to measure a tension of greater than or equal to 500 N, greater than or equal to 1,000 N, greater than or equal to 2,000 N, greater than or equal to 5,000 N, greater than or equal to 10,000 N, greater than or equal to 25,000 N, greater than or equal to 50,000 N, greater than or equal to 75,000 N, greater than or equal to 100,000 N, greater than or equal to 125,000 N, greater than or equal to 150,000 N, greater than or equal to 175,000 N, greater than or equal to 200,000 N, greater than or equal to 225,000 N, or greater. In some embodiments, a tension measuring device is configured to measure a tension of less than or equal to 250,000 N, less than or equal to 225,000 N, less than or equal to 200,000 N, less than or equal to 175,000 N, less than or equal to 150,000 N, less than or equal to 125,000 N, less than or equal to 100,000 N, less than or equal to 75,000 N, less than or equal to 50,000 N, less than or equal to 25,000 N, less than or equal to 10,000 N, or less. Combinations of these ranges are possible. For example, in some embodiments, a tension measuring device is configured to measure a tension of greater than or equal to 5,000 N and less than or equal to 250,000 N. As another example, in some embodiments, a tension measuring device is configured to measure a tension of greater than or equal to 500 N and less than or equal to 250,000 N. However, measured tensions both greater than and less than those noted above are also contemplated as the disclosure is not so limited.

A tension measuring device may be configured to measure tension with any of a variety of appropriate resolutions. In some embodiments, a tension measuring device is configured to resolve wire rope tension with a resolution of less than or equal to 500 N, less than or equal to 450 N, less than or equal to 400 N, less than or equal to 350 N, less than or equal to 300 N, less than or equal to 250 N, less than or equal to 200 N, less than or equal to 150 N, less than or equal to 100 N, less than or equal to 50 N, or less. In some embodiments, a tension measuring device is configured to resolve wire rope tension with a resolution of greater than or equal to 10 N, greater than or equal to 20 N, greater than or equal to 50 N, greater than or equal to 100 N, greater than or equal to 150 N, greater than or equal to 200 N, or greater. Combinations of these ranges are possible. For example, in some embodiments, a tension measuring device is configured to resolve wire rope tension with a resolution of greater than or equal to 10 N and less than or equal to 500 N. However, resolutions both greater than and less than those noted above are also contemplated as the disclosure is not so limited.

As noted previously, it may be desirable to limit deflection of a wire rope in a tension measuring device to reduce errors and provide a more accurate long duration sensor that does not need frequent recalibration. In some such embodiments, a lateral deflection of a wire rope 103 may be measured as a deflection angle α between an axis of a deflected portion of wire rope 103 (e.g., axis 123 of intermediate portion 141) and a longitudinal axis 121 of wire rope 103, see FIG. 1C. The lateral deflection angle may be relatively small. In some embodiments, a wire rope in a tension measuring device has a deflection angle of less than or equal to 10°, less than or equal to 8°, less than or equal to 5°, less than or equal to 2°, less than or equal to 1°, less than or equal to 0.8°, less than or equal to 0.5°, or less. In some embodiments, a wire rope in a tension measuring device has a deflection angle (e.g., a maximum deflection angle) of greater than or equal to 0.01°, greater than or equal to 0.05°, greater than or equal to 0.08°, greater than or equal to 0.1°, greater than or equal to 0.2°, greater than or equal to 0.5°, greater than or equal to 0.8°, greater than or equal to 1°, greater than or equal to 2°, or greater than or equal to 5°, or greater. Combinations of these ranges are possible. For example, in some embodiments, a wire rope in a tension measuring device has a deflection angle of greater than or equal to 0.01° and less than or equal to 10°. However, deflection angles both greater than and less than those noted above are also contemplated as the disclosure is not so limited.

In some embodiments, lateral deflection of wire rope 103 is a lateral displacement 151 of the wire rope, relative to longitudinal axis 121 of the wire rope. Lateral displacement is another way to measure lateral deflection, and may therefore be an important characteristic. The lateral displacement may be used to calculate the deflection angle, or may be used directly, by reformulating the tension measurement in terms of the lateral displacement. In some embodiments, a wire rope in a tension measuring device has a lateral displacement of less than or equal to 25 mm, less than or equal to 22 mm, less than or equal to 20 mm, less than or equal to 18 mm, less than or equal to 15 mm, less than or equal to 12 mm, less than or equal to 10 mm, less than or equal to 8 mm, less than or equal to 5 mm, or less. In some embodiments, a wire rope in a tension measuring device has a lateral displacement of greater than or equal to 0.5 mm, greater than or equal to 1 mm, greater than or equal to 2 mm, greater than or equal to 5 mm, greater than or equal to 8 mm, greater than or equal to 10 mm, greater than or equal to 12 mm, greater than or equal to 15 mm, greater than or equal to 18 mm, greater than or equal to 20 mm, or greater. Combinations of these ranges are possible. For example, in some embodiments, a wire rope in a tension measuring device has a lateral displacement of greater than or equal to 0.5 mm and less than or equal to 25 mm. However, lateral displacements both greater than and less than those noted above are also contemplated as the disclosure is not so limited.

As noted previously, it may be desirable to limit deflection of a wire rope in a tension measuring device to reduce errors and provide a more accurate long duration sensor that does not need frequent recalibration. In some embodiments, a wire rope in a tension measuring device has a lateral displacement of greater than or equal to 0.5%, greater than or equal to 1%, greater than or equal to 2%, greater than or equal to 3%, greater than or equal to 4%, greater than or equal to 5%, greater than or equal to 6%, greater than or equal to 7%, or more of a distance between a first support and a second support. In some embodiments, a wire rope in a tension measuring device has a lateral displacement of less than or equal to 10%, less than or equal to 9%, less than or equal to 8%, less than or equal to 7%, less than or equal to 6%, less than or equal to 5%, less than or equal to 4%, less than or equal to 3%, less than or equal to 2%, or less of a distance between a first support and a second support. Combinations of these ranges are possible. For example, in some embodiments, a wire rope in a tension measuring device has a lateral displacement of greater than or equal to 0.5% and less than or equal to 10% of a distance between a first support and a second support. However, lateral displacements both greater than and less than those noted above are also contemplated as the disclosure is not so limited.

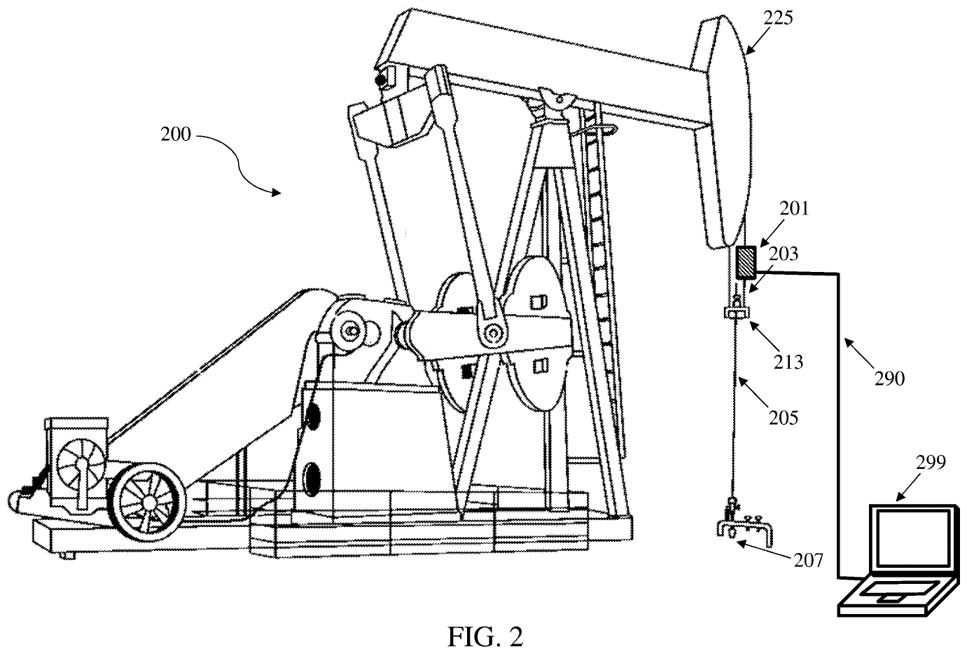

As discussed above, in some embodiments, a tension measuring device described herein is installed on a wire rope of a system for pumping oil (e.g., a pumpjack). FIG. 2 provides a perspective, schematic illustration of a non-limiting embodiment of tension measuring device 201 installed on pumpjack 200. Pumpjack 200 comprises a wire rope 203 that extends through the tension measuring device 201. In pumpjack 200, wire rope 203 connects horse head 225 of pumpjack 200 to carrier bar 213, which is mechanically coupled to rod 205. Rod 205 is sealed to wellhead 207. Thus, tension in wire rope 203 may be used to draw rod 205 upwards during pumping. Accordingly, it may be desirable to measure tension in wire rope 203. One advantage associated with using a tension measuring device in a pumpjack as described herein is that multiple wire ropes 203 are configured to apply tension to carrier bar 213, resulting in a reduced wire rope tension. The reduced wire rope tension may facilitate more accurate, linear measurement of tension, thereby providing a more accurate description of forces acting on a rod-string (not shown) extending from wellhead 207 into a bore. It may be advantageous for tension measuring device 201 to connect to wire rope 203 without being an in-line sensor, since the tension measuring device could thus be installed with less down-time of the pumpjack. Additionally, as the tension measuring device can be attached onto a continuous portion of the wire rope, rather than between two separate portions of wire rope, the forces applied to the tension measuring device may be substantially less than those supported by the individual wire ropes. As shown in FIG. 2, tension measuring device 201 may be operatively coupled to a processor (schematically represented as a computer 299, coupled to tension measuring device 201 by a connection 290) such that the processor may perform a tension measuring method described herein. The operative coupling may be a wired connection, such as connection 290, or may be a wireless connection. The processor may be configured to implement some or all of the methods of a method described herein.

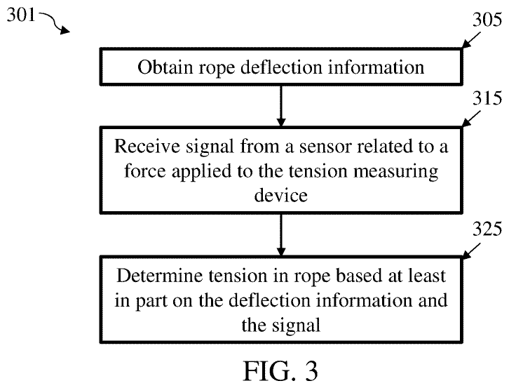

FIG. 3 presents a schematic representation of method 301 of measuring tension, according to some embodiments. As shown, method 301 comprises a first step 305 of obtaining information related to a lateral deflection of a wire rope in a tension measuring device. In some embodiments, a method comprises obtaining information related to a lateral displacement of a wire rope within a tension measuring device. In some embodiments, the method comprises obtaining a deflection angle of the wire rope in a tension measuring device. It should of course be understood that other information regarding lateral deflection of the wire rope may be used in conjunction with or as an alternative to information related to wire rope displacement or deflection angle, and the disclosure is not so limited.

Information related to lateral deflection may be obtained by deflecting the wire rope to a preset value. For example, a wire rope may be deflected to a preset value using a spacer, a fastener, and/or a clamp as described in greater detail above. A spacer may be useful for deflecting the wire rope to a pre-set deflection, as described above. However, in some embodiments, a spacer is not used, and a preset deflection of the wire rope is instead achieved by controlling a fastener's action on a clamp. For example, a fastener may be a screw, and the pre-set deflection of the wire rope may be achieved by turning the screw by a predetermined number of turns, such that a thread of the screw controls the deflection. Tension measuring devices closed using manual control and/or measurement of a clamps, or associated fastener's location, may be calibrated for shorter time periods and/or may be less accurate than using spacers for enforcing pre-set deflections, but can still produce reliable tension measurements. As an alternative to deflecting the wire rope to a preset value, in some embodiments, information related to a lateral deflection of the wire rope may be obtained by measuring lateral deflection of the wire rope (e.g., if lateral deflection of the wire rope is unknown). Other information regarding lateral deflection of the wire rope may be obtained, and the disclosure is not so limited. One or more pieces of information about lateral deflection of the wire rope may be separately obtained, and may be used individually or in combination when determining tension in the wire rope. The information about the lateral deflection may be manually obtained, pre-set, or determined using a processor. In some embodiments, the information about the lateral deflection is provided to the processor for use in subsequent methods steps.

As shown in FIG. 3, method 301 further comprises step 315 of receiving a signal from a sensor. The sensor may be a force sensor. In some embodiments, the signal is related to one or more forces applied to a tension measuring device by wire rope disposed therein. As discussed above, the signal may have a tension-dependent component and a non-tension-dependent component. It should, of course, be understood that steps 305 and 315, and 420 may be performed consecutively in either order, or may be performed simultaneously. Any or all of these steps may, independently, be performed using a processor. In some embodiments, any or all of these steps may be performed manually.

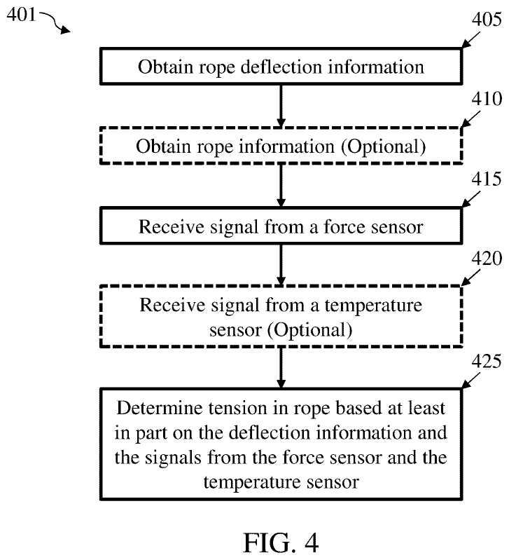

Referring again to FIG. 3, method 301 further comprises step 325 of determining tension in the wire rope based at least in part on the deflection information and the signal. In some embodiments, the tension in the wire rope is determined using additional information, such as wire rope diameter, wire rope condition, ambient temperature, or wire rope design. For example, FIG. 4 provides a schematic illustration of method 401, which is similar to method 301 of FIG. 3, but includes an optional step 410 of obtaining rope information (e.g., rope diameter, rope condition, or rope design) and an optional step 420 of obtaining of receiving signal from a temperature sensor. Like method 301, method 401 comprises step 405 of obtaining wire rope deflection information, which is analogous to step 305 as described in FIG. 3. Method 401 also comprises the step 415 of receiving signal from a force sensor. It should, of course, be understood that steps 405, 415, and 420 may be performed consecutively, in any of a variety of appropriate orders. For example, in some embodiments, temperature may be measured prior to obtaining wire rope deflection information and/or receiving signal from a force sensor. In some embodiments, some of the steps (e.g., step 415 and step 420) are performed simultaneously.

The method may comprise identifying a tension-dependent component of the signal and determining the tension from the tension-dependent component of the signal. Although the tension in the wire rope could, in principle, be determined manually, in some embodiments the tension in the wire rope is determined at least in part by using a processor and a set of processor-executable instructions.

The tension may be determined by any of a variety of appropriate methods. For example referring back to the embodiment of FIG. 1C, wire rope 103 exerts a net force F_{LC} on the load cell. F_{LC} may be resolved into a tension dependent component F_{T} and a tension independent component F_{stiff}, as shown in Eq. 1:

$${F}_{LC} = {F}_{T} + {F}_{Stiff} . \qquad ( 1 )$$

The tension dependent component may be expressed in terms of wire rope tension T and deflection angle α as shown in Eq. 2, reflecting the fact that the tension-dependent component represents the tension component exerting force on the load cell as a result of the deflection of the wire rope:

$${F}_{LC} = T sin ( α ) + {F}_{Stiff} . \qquad ( 2 )$$

Because α is small, in some embodiments the approximation that sin(α)=α is valid and does not introduce a large degree of error. This substitution into Eq. 2 gives rise to:

$${F}_{LC} = α ( T + {K}_{Rope} ) . \qquad ( 3 )$$

In Eq. 3, K_{Rope} is a tension-independent constant resulting from wire rope-stiffness (F_{stiff}=α K_{Rope}). K_{Rope} may reflect the force required to bend the wire rope, even when the wire rope is not under tension. According to some embodiments, F_{LC} is related to the voltage V_{LC} measured by a load cell by Eq. 4 below, where V_{PC} is a power supply voltage, S is a load cell sensitivity, and F_{LCmax} is a maximum bending force for which the load cell is rated.

$${V}_{LC} = {V}_{P S} S \frac{{F}_{LC}}{{F}_{{LC}_{max}}} . \qquad ( 4 )$$

Combining Eq. 2 and Eq. 4 yields Eq. 5 below, expressing wire rope tension in terms of the load cell voltage, the deflection angle, and a tension-independent constant K_{Rope}:

$$T = \frac{{F}_{LC} {V}_{LC}}{{V}_{PS} S α} - {K}_{Rope} . \qquad ( 5 )$$

Eq. 5 provides a reasonable approximation, but in practice S, V_{LC}, and K_{Rope} can be affected by a number of additional variables, such as temperature, wire rope diameter, creep, and wire rope fiber slippage, which create non-linearity in the measured tension. Herein, it has been recognized that by relying on relatively small deflection angles, the effect of properties such as wire rope slippage and creep may be reduced, allowing calibration to remain accurate over long time periods. K_{Rope} depends on temperature dependence, which affects mechanical properties, as well as wire rope diameter. Meanwhile, temperature dependence of S and V_{LC} may arise from thermal expansion and changes in electronic properties of components of the load cell. The temperature correction may be performed based on known models (e.g., based on a known temperature-dependence of V_{LC}. However, it may be advantageous to identify the temperature dependence of these components by consolidating terms of Eq. 5 to express tension in terms of temperature, the wire rope diameter D, and the deflection angle:

$$T = \frac{1}{α} f ( Temperature ) + {K}_{Rope} ( Temperature , D ) . \qquad ( 6 )$$

In Eq. 6, f(Temperature) and K_{Rope}(Temperature, D) are system-dependent. Their values at a given temperature, and for a given wire rope, may be determined by a theoretical understanding of the role that temperature and wire rope diameter play in determining S, V_{LC}, and K_{Rope}. Eq. 6 would be complicated for large displacement angles, because the α dependence could not be separated from f(Temperature) and because K_{Rope} would be α-dependent—this is one advantage of using small displacements.

However, in practice, it may be simpler to perform calibrations to fit for f(Temperature) and K_{Rope}(Temperature, D) using a model. For example, f(Temperature) and K_{Rope}(Temperature, D) may be fit using a linear model, a polynomial model, a neural network, or by any of a variety of other suitable methods. An appropriate model for these parameters may be chosen based on wire rope condition, as well as by the specific electronics and design of the tension measuring device, in order to ensure accurate calibration. Other sources of non-linearity in tension measurement, such as creep and fiber slippage, have unpredictable and time-dependent effects that can drastically increase measurement uncertainty over time. One unexpected result of the forgoing method is that small deflection angles may allow the long-term, accurate calibration of tension measuring devices by circumventing time-dependent sources of uncertainty. In prior art tension measuring devices, tension-independent effects are generally omitted, since tension-dependent effects dominate tension independent effects with large lateral wire rope deformation. Recognizing the need to incorporate K_{Rope} in the model, and understanding its temperature dependence and its dependence on wire rope diameter may improve tension measurement of wire ropes with low deflection angles.

In some embodiments, the tension may be determined based at least in part on the lateral deflection of the rope and the sensed force using one or more of the methods described above. In some embodiments, the tension measurement may be made more accurately, at least in part based on the additional parameters mentioned above—in particular, temperature, rope diameter, and rope condition. Use of the methods described above is not limited to these parameters. Additional refinements may be introduced, e.g., using additional rope properties, rope composition, etc.

In some embodiments, a processor is associated with one or more of the sensors disclosed above. Processors are described in greater detail below. In some embodiments, the processor is configured to accept information from one or more of the sensors, and to perform one or more of the method steps described herein. For example, the processor may be used to determine the tension in the wire rope based at least in part on signals and/or other information provided to the processor.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computing device or distributed among multiple computing devices. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computing device may be embodied in any of a number of forms, such as a rack-mounted computer, a desktop computer, a laptop computer, or a tablet computer. Additionally, a computing device may be embedded in a device not generally regarded as a computing device but with suitable processing capabilities, including a Personal Digital Assistant (PDA), a smart phone, tablet, or any other suitable portable or fixed electronic device.

Also, a computing device may have one or more input and output devices. These devices can be used, among other things, to present a user interface. Examples of output devices that can be used to provide a user interface include display screens for visual presentation of output and speakers or other sound generating devices for audible presentation of output. Examples of input devices that can be used for a user interface include keyboards, individual buttons, and pointing devices, such as mice, touch pads, and digitizing tablets. As another example, a computing device may receive input information through speech recognition or in other audible format.

Such computing devices may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the embodiments described herein may be embodied as a computer readable storage medium (or multiple computer readable media) (e.g., a computer memory, one or more floppy discs, compact discs (CD), optical discs, digital video disks (DVD), magnetic tapes, flash memories, RAM, ROM, EEPROM, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computing devices or other processors to implement various aspects of the present disclosure as discussed above. As used herein, the term “computer-readable storage medium” encompasses only a non-transitory computer-readable medium that can be considered to be a manufacture (i.e., article of manufacture) or a machine. Alternatively or additionally, the disclosure may be embodied as a computer readable medium other than a computer-readable storage medium, such as a propagating signal.

The terms “program” or “software” are used herein in a generic sense to refer to any type of computer code or set of computer-executable instructions that can be employed to program a computing device or other processor to implement various aspects of the present disclosure as discussed above. Additionally, it should be appreciated that according to one aspect of this embodiment, one or more computer programs that when executed perform methods of the present disclosure need not reside on a single computing device or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

The embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

1. A tension measuring device configured to measure tension in a wire rope, the tension measuring device comprising:
a first support configured to support a first portion of the wire rope when the wire rope is disposed in the tension measuring device;
a second support configured to support a second portion of the wire rope when the wire rope is disposed in the tension measuring device, wherein the first and second supports are rigidly coupled together;
a clamp configured to be disposed against an intermediate portion of the wire rope between the first portion and the second portion of the wire rope when the wire rope is disposed in the tension measuring device;
at least one fastener configured to displace at least a portion of the clamp to laterally deflect the intermediate portion of the wire rope;
a spacer configured to limit displacement of the clamp and the associated lateral deflection of the intermediate portion of the wire rope; and
a sensor configured to output a signal related to one or more forces applied to the tensioning measuring device by the wire rope.

2. A tension measuring device as in claim 1, wherein the fastener comprises the spacer.

3. A tension measuring device as in claim 1, wherein the spacer is separate from the fastener and is disposed between the clamp and a rigid body extending between the first support and the second support.

4. A tension measuring device configured to measure tension in a wire rope, the tension measuring device comprising:
a first support configured to support a first segment of the wire rope when the wire rope is disposed in the tension measuring device,
a second support configured to support a second segment of the wire rope when the wire rope is disposed in the tension measuring device, wherein the first and second supports are rigidly coupled together,
a clamp configured to be disposed against an intermediate portion of the wire rope between the first portion and the second portion of the wire rope when the wire rope is disposed in the tension measuring device, and
at least one fastener configured to displace the clamp to laterally deflect the intermediate portion of the wire rope;
a sensor configured to output a signal related to one or more forces applied to the tension measuring device by the wire rope; and
a processor, configured to determine a tension in the wire rope based on a signal from the sensor and a diameter of the wire rope when the wire rope is disposed in the tension measuring device.

5. A tension measuring device as in claim 4, wherein the wire rope is disposed in the tension measuring device.

6. A tension measuring device as in claim 4, wherein the tension measuring device is configured to operate at a temperature between −20° C. and 50° C.

7. A tension measuring device as in claim 4, further comprising a rigid body extending between the first support and the second support

8. A tension measuring device as in claim 7, wherein the at least one fastener is configured to selectively displace the clamp towards and away from the rigid body

9. A tension measuring device as in claim 7, wherein a spacer is configured to limit movement of the clamp such that the wire rope is spaced from the rigid body when the clamp is in a fully clamped configuration.

10. A tension measuring device or method as in claim 7, wherein the rigid body is a portion of a housing of the sensor.

11. A method of determining a tension in a wire rope, the method comprising:
obtaining information related to a lateral deflection of the wire rope within a tension measuring device;
receiving a signal from a sensor, wherein the signal is related to one or more forces applied to the tension measuring device by the wire rope; and
determining the tension in the wire rope based at least in part on the information, the signal, and a diameter of the wire rope.

12. A method as in claim 11, wherein the tension is determined based at least in part on a measured temperature.

13. At least one non-transitory computer-readable storage medium storing processor executable instructions that, when executed by at least one hardware processor, cause the at least one hardware processor to perform a method as in claim 11.

14. A tension measuring device or method as in claim 11, wherein the lateral deflection of the wire rope is a lateral displacement of a portion of the wire rope relative to a longitudinal axis of the wire rope.

15. A method as in claim 11, wherein the lateral deflection of the wire rope is a deflection angle.

16. A method as in claim 11, wherein the wire rope is deflected with a deflection angle that is less than or equal to 10°.

17. A method as in claim 11, wherein the wire rope is laterally displaced by less than or equal to 20 mm relative to a longitudinal axis of the wire rope.

18. A method as in claim 11, wherein the wire rope is displaced relative to a longitudinal axis of the wire rope by less than or equal to 10% of a distance between the first support and the second support.

19. A tension measuring device er method as in claim 11, further comprising identifying a tension-dependent component of the signal and a non-tension-dependent component of the signal, and determining the tension from the tension-dependent component of the signal.

20. A method as in claim 11, wherein the wire rope is a wire rope of a pumpjack.

21. A method as in claim 11, wherein the wire rope is a wire rope of an oil rig.

22. A tension measuring device as in claim 1, wherein the tension measuring device further comprises a temperature sensor.

23. A method as in claim 11, wherein the tension is determined using a condition of the wire rope.

24. A tension measuring device as in claim 5, wherein the sensor does not need to be recalibrated for a period of greater than or equal to 12 months.

25. A tension measuring device as in claim 5, wherein the wire rope has a diameter of greater than or equal to 1 cm and less than or equal to 5 cm.

26. A tension measuring device as in claim 5, wherein the tension in the wire rope is greater than or equal to 1,000 N.

27. (canceled)
